(19) United States
(12) Patent Application Publication
(10) Pub. No.: US 2024/0202194 A1
(43) Pub. Date: Jun. 20, 2024

(54) SEARCH PROCESSING SYSTEM PERFORMING HIGH-VOLUME SEARCH PROCESSING

(71) Applicant: STRATO CO., LTD., Seoul (KR)

(72) Inventors: Hyeong-Doo KIM, Yongin-si (KR); Ho-Chul LEE, Suwon-si (KR); Sun-Kyu PARK, Seoul (KR); Nam-Kyu PARK, Seoul (KR); Yong-Min KWON, Bucheon-si (KR)

(73) Assignee: STRATO CO., LTD., Seoul (KR)

(21) Appl. No.: 18/500,332

(22) Filed: Nov. 2, 2023

(30) Foreign Application Priority Data
Dec. 16, 2022 (KR) 10-2022-0176752

(51) Int. Cl. G06F 16/2455; G06F 11/34; G06F 16/27

(52) U.S. Cl. CPC G06F 16/24553; G06F 11/3419; G06F 16/278

(57) ABSTRACT

Provided is a search processing system performing high-volume search processing. The search processing system includes: a synchronization database server; a search server configured to match search result data and primary key field values and temporarily store them and to continuously transmit the matched primary key field values and the search result data to the synchronization database server to perform mutual real-time synchronization; and a search node configured to receive and store the primary key field values among the search result data from the search server.

### CROSS-REFERENCE TO RELATED APPLICATIONS

This application claims the benefit of Korean Application No. 10-2022-0176752, filed Dec. 16, 2022, in the Korean Intellectual Property Office. All disclosures of the document named above are incorporated herein by reference.

### TECHNICAL FIELD

The present invention relates to a search processing system that performs high-volume search processing, and more particularly, to a search processing system that processes search data by including a search server having a limitation in the total number of processing.

### BACKGROUND ART

Cloud computing technology is used in various fields, and the representative field of cloud computing technology is high-volume data search services.

In general, when cloud-based high-volume data is searched, a search engine (a search server) such as Elasticsearch or the like is used for high search speed, and this search server has a limitation in the amount of search result data.

For example, in the case of the Elasticsearch search server, only 10,000 search result data can be retrieved by default, and an error is generated when more pieces of data are present.

In other words, in the case of the Elasticsearch search server, for efficiency, pieces of data are distributed and stored in multiple databases rather than one database by using a Sharding technique, and when the pieces of data are collected, similarly, a process of collecting, aligning and converting the data by using the Sharding technique has undergone. Thus, the maximum number of search result data (i.e., documents) is limited to 10,000.

Of course, the most fundamental solution is to set the default value of max_result_window size in the settings of the Elasticsearch search server to be greater than 10,000. However, when the default value is changed, performance problems occurs due to the excessive use of resources.

### PRIOR-ART DOCUMENT

(Patent document 1) Korean Patent Registration No. 10-1932655

### DISCLOSURE OF THE INVENTION

The present invention provides a data system in which a problem that high-volume data cannot be processed due to data limitation when search is performed using only the Elasticsearch search server can be solved.

According to an aspect of the present invention, there is provided a search processing system including: a synchronization database server; a search server configured to match search result data and primary key field values and temporarily store them and to continuously transmit the matched primary key field values and the search result data to the synchronization database server to perform mutual real-time synchronization; and a search node configured to receive and store the primary key field values among the search result data from the search server, wherein the search node may transmit the stored primary key field values to the synchronization database server and receive search result data matched with each of the primary key field values.

The search node may search a total count value of the search result from the search server, and when the searched total count value exceeds a preset value, the search node may receive and store the primary key field value and then may transmit the stored primary key field values to the synchronization database server and may receive search result data matched with each primary key field value from the synchronization database server, and when the searched total count value is less than the preset value, the search node may request and receive the search result data from the search server, and

After requesting search to the search server, when the total count value searched from the search server exceeds the preset value, the search node may request split search from the search server.

The search node may determine individual thread processing amount for data processing based on its own amount of Information Technology (IT) resources, may determine a number of threads to be created for data processing based on the determined individual thread processing amount and the searched total count value, may create threads as many as the determined number of threads, may distribute and align each primary key field value to each of the threads and then may control each thread to receive search result data from the synchronization database server based on the primary key field value.

When determining individual thread processing amount for data processing based on its own amount of IT resources, the search node may apply weights based on statistical values determined based on a total processing time for search requests.

### BRIEF DESCRIPTION OF THE DRAWINGS

FIG. 1 is a diagram illustrating the main configuration of a search processing system according to an embodiment of the present invention; and

FIGS. 2 and 3 are the entire control flowcharts illustrating a search processing system according to an embodiment of the present invention.

### DETAILED DESCRIPTION FOR CARRYING OUT THE INVENTION

Hereinafter, the present invention will be described in detail with reference to the accompanying drawings.

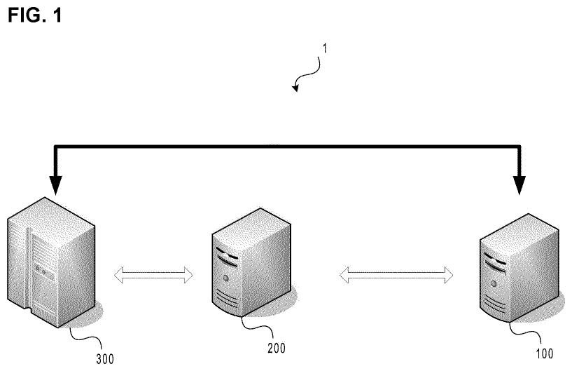

The main configuration of a search processing system according to an embodiment of the present invention is as illustrated in FIG. 1.

As illustrated in the same drawing, the search processing system may include a search node 100, a search server 200, and a synchronization database server 300.

Here, the synchronization database server 300 performs a function of sharing data with the search server 200, storing and managing the data, and providing the stored data when there is a request from the search node 100.

For example, the synchronization database server 300 may correspond to mongoDB.

The function of real-time synchronizing and storing data from the outside and providing at least part of the data to the outside itself is a well-known technology and thus, detailed descriptions thereof will be omitted.

The search server 200 performs search processing according to external search requests, and may be, for example, an Elasticsearch server corresponding to a Lucene-based search engine.

In particular, the search server 200 matches search result data and Primary Key field values and temporarily stores them, and also continuously transmits the matched Primary Key field values and search result data to the synchronization database server 300 and performs mutual real-time synchronization.

For example, the search server 200 may synchronize search result data that is newly generated when there is a search request, with the synchronization database server 300 in the above-described manner. In this case, both old search result data and newly-synchronized search result data can also be stored in the synchronization database server 300. In contrast, the search server 200 can only store search result data that occurred during a preset time.

That is, the total amount of data stored in the synchronization database server 300 may be greater than the total amount of data stored in the search server 200. However, all of at least the search result data stored in the search server 200 may be stored in the synchronization database server 300, and in this case, the Primary Key field values are also stored in the same manner.

Thus, the same search result data can be obtained regardless of whether a request is made to the search server 200 or the synchronization database server 300 based on a specific Primary Key field value.

It is assumed that at least one of data storage capacity, storage time or high-volume processing performance of the search server 200 is lower or limited compared to the synchronization database server 300.

The search node 100 requests a search from the search server 200 and receives the corresponding results, and in particular, the search node 100 may perform a function of requesting search processing from the search server 200 according to a request from a user, etc., and providing search result data using information received from the search server 200 according to such request to the user, etc.

When requesting search processing from the search server 200, the search node 100 may also search the total count value of the search result data firstly.

For example, the search node 100 may request and receive the total count value of the search result data according to a corresponding search query while transmitting the search query to the search server 200, and may perform different processing according to the received total count value.

Specifically, when the searched total count value is less than a preset value, the search node 100 may request and receive the search result data directly from the search server 200.

On the other hand, when the searched total count value exceeds the preset value, the search node 100 may request and receive Primary Key field values from the search sever 200 and store them and then may receive the search result data from the synchronization database server 300 by using the stored Primary Key field values.

That is, as described above, pieces of data stored in the search server 200 are synchronized with the synchronization database server 300 and thus, the search node 100 may request and receive necessary search result data from the synchronization database server 300. In this case, the Primary Key field values received from the search server 200 are used.

In an example, the search server 200 may sequentially request and receive the search result data matched with each Primary Key field value from the synchronization database server 300.

Meanwhile, when the total count value searched from the search server 200 exceeds the preset value, as described above, the search node 100 may also request split search from the search server 200.

When a general search request returns a single result, the above-described split search request returns a large number of results.

Assuming that the search server 200 is an Elasticsearch server, the above-described split search request may be a so-called Scroll Application Programming Interface (API) request.

Technology related to the Scroll API request itself is a well-known technology and thus, more detailed descriptions thereof will be omitted.

In particular, when connecting to the synchronization database server 300 and receiving the search result data, the search node 100 may perform search processing by using a plurality of threads.

To this end, the search node 100 may determine the amount of individual thread processing for data processing based on its own amount of Information Technology (IT) resources (e.g., the number of cores of a Central Processing Unit (CPU), a memory size, etc.).

Here, an algorithm for calculating the amount that each of the threads can process based on the amount of IT resources that are currently available can use a known method.

As an example, when the number of cores of the CPU is 4, the search node 100 may determine that the amount that each individual thread can process is 600. As another example, when the number of cores of the CPU is 8, the search node 100 may determine that the amount that each individual thread can process is 1,000.

Also, the search node 100 may determine the number of threads to be created for data processing based on the determined individual thread processing amount and the previously searched total count value.

For example, when the amount of individual thread processing is 1,000 and the total count value searched from the search server 200 is 10,000, the search node 100 may determine that 10 threads are needed by calculating 10,000/1,000.

Subsequently, the search node 100 may create threads as many as the determined number of threads, may distribute and assign each Primary Key field value to each thread, and then may control each thread to receive the search result data from the synchronization database server 300 based on the corresponding Primary Key field value.

For example, a first thread may request and receive search result data corresponding to Primary Key field values 1 to 1000 from the synchronization database server 300, and a second thread may request and receive search result data corresponding to Primary Key field values 1001 to 2000, and a third thread may request search result data corresponding to Primary Key field values 2001 to 3000 from the synchronization database server 300.

This processing can be performed in the same manner for the remaining fourth to tenth threads.

Meanwhile, when determining the amount of individual thread processing for data processing based on the amount of its own IT resources, the search node 100 may apply weights based on statistical values determined based on the total processing time for search requests.

For example, the search node 100 stores the total processing time using a plurality of threads each time, and at this time, the total count value, individual thread processing amount, amount of IT resources, etc. may be matched and stored.

For example, depending on the amount of IT resources, the amount of thread processing may be prioritized, or the number of threads may be prioritized. Although the above-described processing process is an example in which the amount of thread processing is applied first, when the total processing time stored for each processing for each search request is accumulated and stored and then is analyzed statistically, a specific pattern may be derived. Thus, the search node 100 may perform search processing by assigning a weight that prioritizes the number of threads based on this specific pattern.

As another example, as a result of checking the processing time using threads for various searches with the total count value within a preset range with the same IT resources, the amount of individual thread processing in the top 20% with the fastest processing time was averaged. For future search processing with total count values in a similar range, the average value may be selected as the amount of individual thread processing.

In this case, weights may be applied to the ratio of using the average value based on these statistics and the ratio of using a preset algorithm, respectively. For example, weights may be applied based on a difference between the average of the top 20% with the fastest processing time and the overall average so that, when the difference is large, the frequency of using the above-mentioned upper average value may be increased.

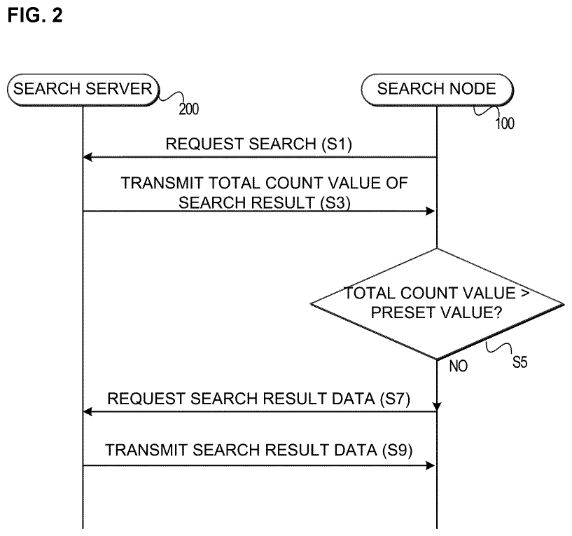

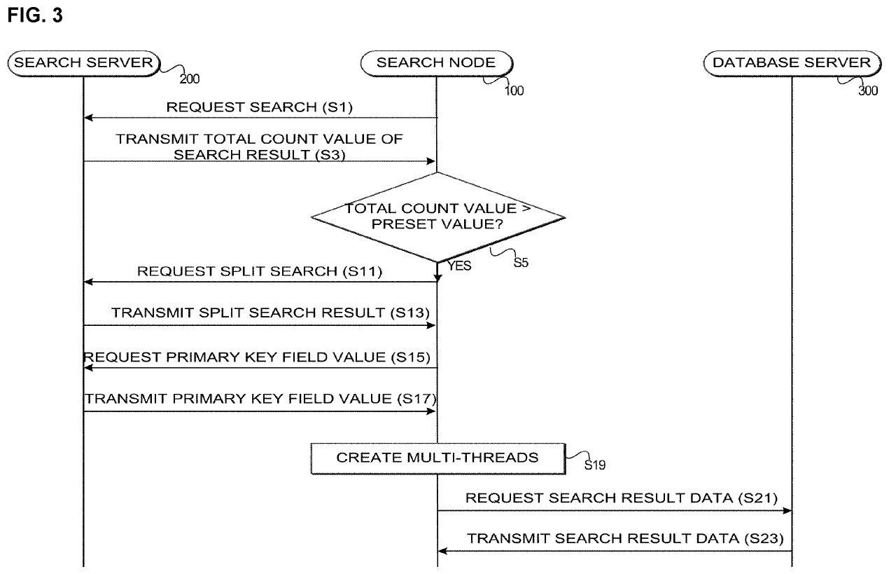

Hereinafter, the entire control flow of the search processing system according to an embodiment of the present invention will be described with reference to FIGS. 2 and 3.

First, it will be described with reference to FIG. 2 as follows.

The search node 100 makes a search request to the search server 200 (operation S1).

According to this search request, the search server 200 performs search processing and then transmits the total size, that is, the number (referred to as ‘total count value’) of the search result data to the search node 100 (operation S3).

When the total count value received from the search server 200 is not greater than (is less than) the preset value (operation S5), the search node 100 requests transmission of the search result data from the search server 200 (operation S7).

The search server 200 extracts the search result data according to the request of search result data transmission of the search node 100 and transmits the extracted result to the search node 100 (operation S9).

The search node 100 may perform processing of the search result data received from the search server 200 according to its own needs or may transmit the search result data to the user (not shown) who requested search in the first place, etc.

Next, it will be described with reference to FIG. 3 as follows.

When describing the present embodiment, the case where the search server 200 is an Elasticsearch server, is an example.

In FIG. 3, operations S1 through S5 are the same as those of FIG. 2 and thus, redundant descriptions therewith will be omitted.

When the total count value received from the search server 200 is greater than the preset value (operation S5), the search node 100 transmits a split search request from the search server 200 (operation S11), for example, requests Elasticsearch Scroll API search.

Here, when requesting Elasticsearch Scroll API search, the search node 100 may set size, scroll timeout, etc. and request and then store a scroll_id value and perform consequent search request by using the stored scroll_id value.

The search server 200 transmits the result of split search to the search node 100 (operation S13). When there is a document to be received through Scroll API communication, the search node 100 continuously requests and receives the Primary Key Field value (operation S15). In this case, the received Primary Key field value may be temporarily stored (operation S17).

As an example, the search node 100 may store the Primary key field value received from the search server 200 in a Kafka messaging queue, etc.

Although not shown, when the entire document (i.e., the entire Primary Key field value) is received through Scroll API communication with the search server 200, the search node 100 may request the removal of search contents related to the search server 200, i.e., context, when Scroll_id is alive, and may allow the removal of context.

Meanwhile, the search node 100 creates multi-threads (operation S19). In this case, the processing amount and number may be calculated according to a predetermined algorithm.

For example, the search node 100 automatically calculates the optimal Range Fetch Size value for each thread by calculating the physical core and memory values as its own spare resources.

Also, the search node 100 may generate Thread Task by calculating the Range Fetch Size based on the entire document.

The search node 100 distributes all Primary Key field values to these threads and then controls each thread to request (operation S21) and receive (operation S23) search result data from the synchronization database server 300.

In this case, when one Thread Task is completed, the search results may be delivered (may respond) to the user in real time, and when all Thread Tasks are completed, the search result completion API may be communicated to the user.

Furthermore, the search node 100 may remove corresponding Kafka messaging queue Topic.

Meanwhile, the process of performing each of the above-described embodiments can be performed by a program or application stored in a predetermined recording medium (e.g., computer-readable). Here, recording media include electronic recording media such as Random Access Memory (RAM), magnetic recording media such as hard disks, and optical recording media such as Compact Disks (CDs).

In this case, the program stored in the recording medium can be executed on hardware such as a computer or smartphone to perform each of the above-described embodiments.

As described above, according to the present invention, when high-volume data is searched by using an Elasticsearch search engine and when the number of search exceeds 10,000, only a Primary Key field is searched so that the high-volume data can be searched in mongoDB by using Primary Key and Mapping of mongoDB and thus a problem of service down can be prevented from occurring due to efficient resource management and resource limitation.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A search processing system comprising:
a synchronization database server;
a search server configured to match search result data and primary key field values and temporarily store them and to continuously transmit the matched primary key field values and the search result data to the synchronization database server to perform mutual real-time synchronization; and
a search node configured to receive and store the primary key field values among the search result data from the search server,
wherein the search node searches a total count value of the search result from the search server, and when the searched total count value exceeds a preset value, the search node receives and stores the primary key field value and then transmits the stored primary key field values to the synchronization database server and receives search result data matched with each primary key field value from the synchronization database server, and when the searched total count value is less than the preset value, the search node requests and receives the search result data from the search server, and
after requesting search to the search server, when the total count value searched from the search server exceeds the preset value, the search node requests split search from the search server.

2. The search processing system of claim 1, wherein the search node determines individual thread processing amount for data processing based on its own amount of Information Technology (IT) resources, determines a number of threads to be created for data processing based on the determined individual thread processing amount and the searched total count value, creates threads as many as the determined number of threads, distributes and aligns each primary key field value to each of the threads and then controls each thread to receive search result data from the synchronization database server based on the primary key field value.

3. The search processing system of claim 2, wherein, when determining individual thread processing amount for data processing based on its own amount of IT resources, the search node applies weights based on statistical values determined based on a total processing time for search requests.

4. A computer-readable recording medium having on a program for executing a function of the search processing system of claim 1 recorded thereon.

5. A computer-readable recording medium having on a program for executing a function of the search processing system of claim 2 recorded thereon.

6. A computer-readable recording medium having on a program for executing a function of the search processing system of claim 3 recorded thereon.
